(19) United States
(12) Patent Application Publication
(10) Pub. No.: US 2026/0177777 A1
(43) Pub. Date: Jun. 25, 2026

(54) LENS DRIVING DEVICE, CAMERA AND ELECTORNIC EQUIPMENT

(71) Applicant: XIAMEN ZHONGHUI MICROELECTRONICS CO., LTD, Xiamen (CN)

(72) Inventors: Chaochun Chang, Taibei (CN); Yuqin Yi, Xiamen (CN)

(21) Appl. No.: 19/087,519

(22) Filed: Mar. 23, 2025

(30) Foreign Application Priority Data
Dec. 23, 2024 (CN) 202423169023.3

(51) Int. Cl. G02B 7/04; G03B 3/10; G03B 5/00

(52) U.S. Cl. CPC G02B 7/04; G03B 3/10; G03B 5/00; G03B 2205/0069

(57) ABSTRACT

A lens driving device includes a base, a cover, a carrier, a driving unit and a guide unit. The guide unit is used for guiding the carrier to move relative to the base along an optical axis of a lens unit hold by the carrier, and includes a first guide groove, a second guide groove, a first guide member and a second guide member. The first guide member includes one or two or two more arc-shaped surfaces or hemispherical surfaces which are in line or point contact with the first guide groove. The second guide includes one or two or two more arc-shaped surfaces or hemispherical surfaces which are in line or point contact with the second guide groove.

### CROSS-REFERENCE TO RELATED APPLICATION

The present application claims priority of China Patent Application No. 202423169023.3, filed on Dec. 23, 2024, the contents of which are incorporated herein by reference.

### BACKGROUND OF THE INVENTION

### 1. Technical Field

The present application relates to camera lens driving devices, and in particular to a micro lens driving device, a camera and an electronic equipment.

### 2. Description of Related Art

Existing camera lens driving device guide units are complex and difficult to assemble, which not only increases production costs, but also reduces production efficiency. Due to the complexity of structural design, these lens driving devices are often large in size, which limits their pursuit of application in products with thin and light design. Therefore, in order to meet the market demand for cost-effectiveness and thinness, simplifying the guiding unit, reducing assembly difficulty and cost, in order to improve product production efficiency and achieve thinness of products, has become an urgent need for the development of the industry.

### SUMMARY OF THE INVENTION

In order to solve the technical problems that in the related art, the present invention provides a lens driving device with a simple structure and light weight.

The lens driving device mainly includes a base, a cover, a carrier, a driving unit and a guide unit. The cover and the base are connected to form a fixing part with a receiving space. The carrier is movably arranged in the receiving space for carrying a lens unit. The driving unit is used for driving the carrier to move relative to the fixing part. The guide unit is used for guiding the carrier to move relative to the base along an optical axis direction of the lens unit, and includes a first guide groove, a second guide groove, a first guide member and a second guide member. The first guide member includes one or two or two more arc-shaped surfaces or hemispherical surfaces protruding towards the first guide groove and arranged along a first direction parallel with the optical axis direction, the one or two or two more arc-shaped surfaces or hemispherical surfaces are in line or point contact with the first guide groove, and the number of contact lines or contact points is greater than or equal to 2. The second guide includes one or two or two more arc-shaped surfaces or hemispherical surfaces protruding towards the second guide groove and arranged along a second direction parallel with the optical axis direction, the one or two or two more arc-shaped surfaces or hemispherical surfaces are in line or point contact with the second guide groove, and the number of contact lines or contact points between the second guide member and the second guide groove is greater than or equal to 1. The first guide groove is defined in one of the base and the carrier, and the first guide member is fixedly connected to the other of the base and the carrier. The second guide groove is defined in one of the base and the carrier, and the second guide member is fixedly connected to the other of the base and the carrier.

In the lens driving device of the present invention, the first guide member is in line or point contact with the first guide groove, and the number of the contact lines or contact points between the first guide member and the first guide groove is greater than or equal to 2, the first guide member and the first guide groove not only have a guiding effect in the first direction parallel with the optical axis direction, but also have a limiting effect on the base and the carrier in the direction perpendicular to the optical axis. By bringing the second guide member and the second guide groove into line or point contact, and making the number of contact lines and contact points between the second guide member and the second guide groove greater than or equal to 1, the second guide member and the second guide groove can only achieve a guiding effect in the second direction parallel with the optical axis direction and do not have a limiting effect perpendicular to the optical axis direction, thereby reducing the processing accuracy requirements for the second guide groove and easily ensuring product yield. The first guide member and the second guide member are fixedly connected with the base or the carrier, thereby simplifying the assembly process. Compared with movable guide members adopted in the prior art, the invention significantly reduces assembly time and the need for special tools, thereby shortening the product market cycle. The first guide member and the second guide member fixedly connected to the base or carrier reduce potential errors caused by part assembly, improve the overall quality and yield of the product, and effectively save costs. At the same time, it ensures high-precision positioning of the guide members, reduces deviations, improves the guidance performance and response speed of the lens driving device, and has a positive impact on imaging quality and user experience. In addition, the fixed guide structure reduces the weight and volume, meeting the market demand for thinness, while enhancing integrity and durability, improving impact and vibration resistance, and extending the service life of the lens driving device. During daily use or transportation, the fixed guide structure is more resistant to damage from external forces, ensuring the stable operation of the lens driving device in various environments. The automated batch production capability of the manufacturing process is conducive to the unification and standardization of product quality, reduces the defective rate, and provides solid quality guarantee for mass production. These advantages not only improve the technical content of the product, but also enhance the market competitiveness of the product, especially in the field of portable electronic devices that have high requirements for thinness and high performance.

### BRIEF DESCRIPTION OF THE SEVERAL VIEWS OF THE DRAWINGS

The foregoing and other exemplary purposes, aspects and advantages of the present invention will be better understood in principle from the following detailed description of one or more exemplary embodiments of the invention with reference to the drawings, in which:

FIG. 1 is an exploded view of a lens driving device in accordance with a first embodiment of the present invention.

FIG. 2 is a top view of a part of the lens driving device of FIG. 1.

FIG. 3 is an exploded view of a lens driving device in accordance with a second embodiment of the present invention.

FIG. 4 is a partial view of the lens driving device in FIG. 2.

FIG. 5 is a top view of a part of the lens driving device in FIG. 2.

FIG. 6 is an exploded view of a lens driving device in accordance with a third embodiment of the present invention.

FIG. 7 is a partial view of the lens driving device in FIG. 4.

### DETAILED DESCRIPTION OF THE INVENTION

The invention will now be described in detail through several embodiments with reference to the accompanying drawings.

It should be noted that like numerals and letters indicate like items in the following figures, so that once an item is defined in one figure, no further definition or explanation is required in subsequent figures. In the description of embodiments of the present application, it should be understood that the orientation or positional relationship indicated by the terms “upper”, “lower”, “left”, “right”, “vertical”, “horizontal”, etc. are based on the orientation or positional relationship shown in the drawings, or the orientation or positional relationship that the products of the application are usually placed when used, or the orientation or positional relationship commonly understood by those skilled in the art, and are only for convenience in describing the present application and simplifying the description. It does not indicate or imply that the device or element referred to must have a particular orientation, be constructed and operate in a particular orientation, and therefore cannot be construed as a limitation on the present application.

It should be noted that the embodiments in this application and features in the embodiments can be combined with each other without conflict.

### First Embodiment

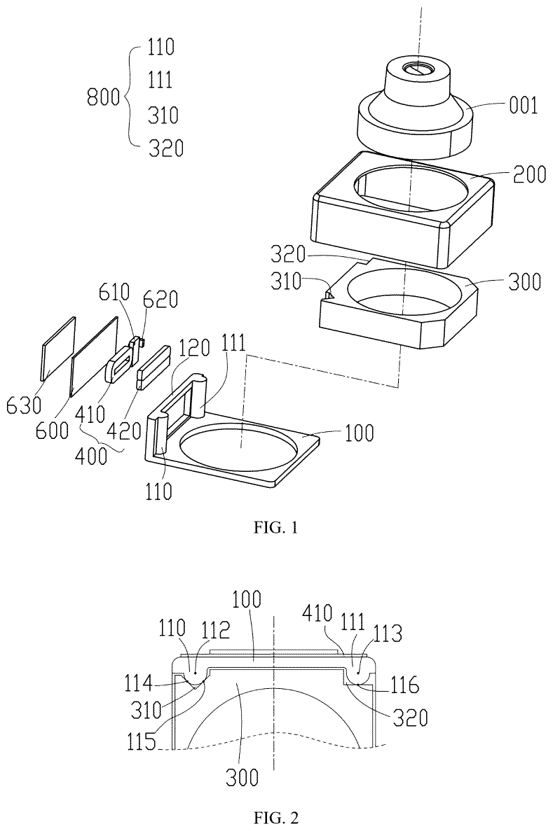

Please refer to FIG. 1. The lens driving device in this embodiment mainly includes a base 100, a cover 200 fixed to the base 100, a carrier 300 used for carrying a lens unit 001, and a driving unit 400 used for driving the carrier 300 to move. The driving unit 400 mainly includes a coil unit 410 and a magnet unit 420. The lens unit 001 may include one or more lenses. The cover 200 is connected with the base 100 to form a fixing part having a receiving space. The carrier 300 serves as a movable part and is movably arranged in the receiving space of the fixing part. A guide unit 800 used for guiding the carrier 300 to move relative to the base 100 is provided between the base 100 and the carrier 300. The guide unit 800 mainly includes a first guide member 110, a second guide member 111, a first guide groove 310, and a second guide groove 320. The first guide member 110 and the second guide member 111 are preferably integrally formed with the base 100, and the first guide groove 310 and the second guide groove 320 are preferably integrally formed with the carrier 300, and are both made of a non-conductive material, such as plastic.

Compared with the split/movable guide structure, the structure that the first guide member 110, the second guide member 111 are fixedly connected/integrally formed with the base 100 makes it unnecessary to assemble the guide members during the assembly process, which significantly reduces the assembly time and the required special tools greatly simplify the assembly process and shorten the product launch cycle. At the same time, it also eliminates errors caused by part assembly, improves the overall quality and yield of the product, and effectively saves costs. The fixed connection/integrated design of the first guide member 110 and the second guide member 111 with the base 100 ensures that the positional accuracy of the first guide member 110 and the second guide member 111 is much higher than that can be achieved by processing an independent guide member separately and then assembling it to the base. This high-precision positioning is achieved by precision machining the base 100 itself to ensure the straightness and stability of the carrier 300 when moving in focus along the optical axis, thereby reducing friction and deviation, thereby significantly improving the guidance performance and response speed of the lens driving device., has a direct and positive impact on imaging quality and user experience. The base 100 with the first guide member 110 and the second guide member 111 is made by using fixed connection/integrated molding technology. Compared with using independent metal first guide member 110 and the second guide member 111 in traditional lens driving devices, the base 100 not only reduces the weight, but also helps to reduce the overall volume, allowing the camera module to better meet the needs of today's market for thinness and lightness. When integrally formed, there is no splicing gap between the first guide member 110 and the second guide member 111 and the base 100 on which they are located, which has high structural strength, better impact and vibration resistance, and effectively extends the service life of the lens driving device. During daily use or transportation, it is more resistant to damage from external forces, ensuring that the lens driving device can operate stably in various environments. The manufacturing process of the first guide member 110 and the second guide member 111 makes it easier to achieve automated mass production, which is conducive to the unification and standardization of product quality, reduces the defective rate of individual parts, and provides solid quality guarantee for mass production.

In this embodiment, the first guide member 110 and the second guide member 111 are integrally formed on the base 100, that is, the base 100 is integrally formed and has the first guide member 110 and the second guide member 111 after being manufactured, and can be integrally formed of plastic.

Compared with metal, plastic is light, which effectively reduces the overall weight of the lens driving device and conforms to the trend of making electronic products thinner and thinner. It is especially suitable for mobile phone camera modules and can contribute to the lightness of terminal equipment. Plastic products have low cost, are easy to produce on a large scale, reduce manufacturing costs, and enable high-quality lens driving devices to be popularized in more consumer-grade products, benefiting consumers. Plastic has a certain degree of elasticity, can absorb vibration and impact to a certain extent, protect internal components, and improve the durability and life of the lens driving device.

In this embodiment, the first guide member 110 and second guide member 111 are respectively disposed on two sides of the coil unit 410 and are disposed symmetrically relative to the optical axis of the lens driving device.

The first guide member 110 and the second guide member 111 can provide enough support points to ensure that the carrier 300 remains stable during the focusing process and reduce shaking. The symmetrical distribution enhances the sense of balance and improves the accuracy and reliability of motion. The layout of two guide members: the first guide member 110 and the second guide member 111 occupies relatively small space and is suitable for compact design, especially for applications in limited spaces. At the same time, it reduces the use of materials and conforms to the green design concept.

In this embodiment, the first guide member 110 and the second guide member 111 both include a substantially cylindrical part, the central axes (extending directions) of the two cylindrical parts are perpendicular to the base 100.

The two first guide member 110 and the second guide member 111 provide sufficient support points to ensure that the carrier 300 remains stable during the focusing process. The symmetrical distribution enhances movement balance and improves the accuracy and reliability of focusing. The layout of the dual guide members: the first guide member 110 and the second guide member 111 occupies relatively small space and is suitable for compact design, especially for applications in limited spaces. At the same time, it reduces the use of materials and conforms to the green design concept.

Please also referring to FIG. 2, in this embodiment, the first guide member 110 and the second guide member 111 both include a substantially cylindrical part, the cylindrical parts extend substantially perpendicularly from a base board of the are base 100 along extending directions 112, 113 (shown as two points in FIG. 2), respectively. The extending directions 112, 113 are parallel to the optical axis direction. The arc-shaped surfaces of the cylindrical parts face the outer surface (outer sidewall) of the carrier 300. The outer side wall of the carrier 300 is provided with a first guide groove 310 and a second guide groove 320. The first guide groove 310 and the second guide groove 320 correspond to the first guide member 110 and the second guide member 111 one by one. The first guide groove 310 is in line contact with the arc-shaped surface of the first guide member 110 with at least two contact lines 114, 115 (shown as two points in FIG. 2), and the second guide groove 320 is also in line contact with the arc-shaped surface of the second guide member 111 with one contact line 116 (shown as a point in FIG. 2). In this embodiment, when viewed from the optical axis direction, the first guide groove 310 has a V shape, and the two surfaces forming the V shape are in line contact with the arc-shaped surface of the first guide member 110 respectively, thereby generating two contact lines 114, 115, and neither of the two surfaces forming the V shape is perpendicular to the winding plane of the coil unit 410 (i.e., not parallel to the winding axis of the coil). The two contact lines 114, 115 between the first guide member 110 and the first guide groove 310 are at two sides of the extending direction 112 when viewed in a direction intersect with the extending direction 112 and perpendicular to the winding plane of the coil unit 410. The contact line 116 is in a line which intersect with the extending direction 113 and perpendicular to the winding plane of the coil unit 410. The groove bottom of the second guide groove 320 is a plane, and the plane is substantially parallel to the winding plane of the coil unit 410. In use, only the groove bottom is in line contact with the arc-shaped surface of the second guide member 111, and the rest of the second guide groove 320 is not in contact with the second guide member 111, thereby creating only one contact line 116.

During the focusing process, the carrier 300 moves in/along the optical axis direction, and the arc-shaped surfaces of the first guide member 110 and the second guide member 11 generate sliding friction with the first guide groove 310 and the second guide groove 320. Therefore, a lubricant or gel may be disposed between the first guide member 110 and the first guide groove 310, and also may be disposed between the second guide member 111 and the second guide groove 320 to reduce friction.

The first guide member 110 and the first guide groove 310 are in multi-line (that is, more than one contact line) contact fit, and the second guide member 111 and the second guide groove 320 are in single-line contact fit, thus, capable of providing stable focusing movement direction guide and ensuring that the carrier 300 continues to move stably during the focusing process. The first guide groove 310 and the first guide member 110 are in multi-line contact fit, increasing the contact area, thereby enhancing the stability of the structure. This stability is crucial for maintaining accurate focusing of the lens unit 001 under various use conditions. The second guide groove 320 is in single-line contact with the second guide member 111, which reduces the friction generated when the carrier 300 moves, reduces the volume of the guide unit, effectively utilizes the limited space inside the lens driving device, and is particularly suitable for small-sized equipment with limited space, such as a camera of a smartphone. By optimizing space utilization, ultra-miniaturization of equipment can be achieved without sacrificing performance.

The coil unit 410 and the magnet unit 420 are opposed to each other with space. The coil unit 410 is fixed between the first guide member 110 and the second guide member 111. The magnet unit 420 is fixed on the outer sidewall of the carrier 300 and is located between the first guide groove 310 and the second guide groove 320. When the coil unit 410 is energized, Lorentz force is generated between the coil unit 410 and the magnet unit 420 to drive the carrier 300 to move relative to the base 100. In this embodiment, the coil unit 410 only includes one coil, the winding plane of the coil is parallel to the optical axis of the lens unit 001, and the coil is generally in the shape of an oblong, and two long sides are perpendicular to the optical axis of the lens unit 001. The magnet unit 420 has two opposite polarities in a surface which faces the two long sides of the coil. In the embodiments, the magnet unit 420 includes two magnets opposed to the long sides of the coil respectively.

The configuration of a single coil and a single magnet unit 420 can greatly reduce the height of the lens driving device without affecting performance.

In this embodiment, the coil unit 410 is mounted on a circuit board 600. A chip 610 and a capacitor 620 are also mounted on the circuit board 600. The coil unit 410, the chip 610, and the capacitor 620 are arranged side by side on the same surface of the circuit board 600, and the other surface of the circuit board 600 is attached to a metal reinforcing plate 630. The base 100 further includes a connecting beam 120 connected to upper ends of the first guide member 110 and the second guide member 111. The connection beam 120, the first guide member 110, the second guide member 111, and a side edge of the base 100 constitute a frame for fixing the circuit board 600, and form an opening used for receiving the coil unit 410, the chip 610, and the capacitor 620, making the installation of the circuit board 600 easier and more stable. The metal reinforcing plate 630 may be made of iron or steel.

By arranging the coil unit 410, the chip 610, and the capacitor 620 side by side on the same side of the circuit board 600, the overall volume of these components can be compressed. The design of adding a metal reinforcing plate 630 to the other side of the circuit board 600 effectively enhances the mechanical strength and impact resistance of the entire structure. The metal reinforcing plate 630 not only provides necessary physical protection to avoid line damage caused by external pressure or vibration, but also serves as a heat dissipation medium to help remove heat generated by internal components and maintain stable operation of electronic equipment in a high temperature environment. The magnetic attraction between the metal reinforcing plate 600 and the magnet unit 420 can also ensure that the first guide groove 310 and the second guide groove 320 maintain contact with the first guide member 110 and the second guide member 111, ensuring guiding effectiveness.

Fixing the magnet unit 420 on one side of the carrier 300 helps prevent the magnetic field from adversely affecting electrical components external to the lens driving device, such as reducing magnetic coupling effects, thereby improving the safety and reliability of the overall circuit. The coil unit 410 is fixed to one side of the base 100 to facilitate the layout of the power supply line.

### Second Embodiment

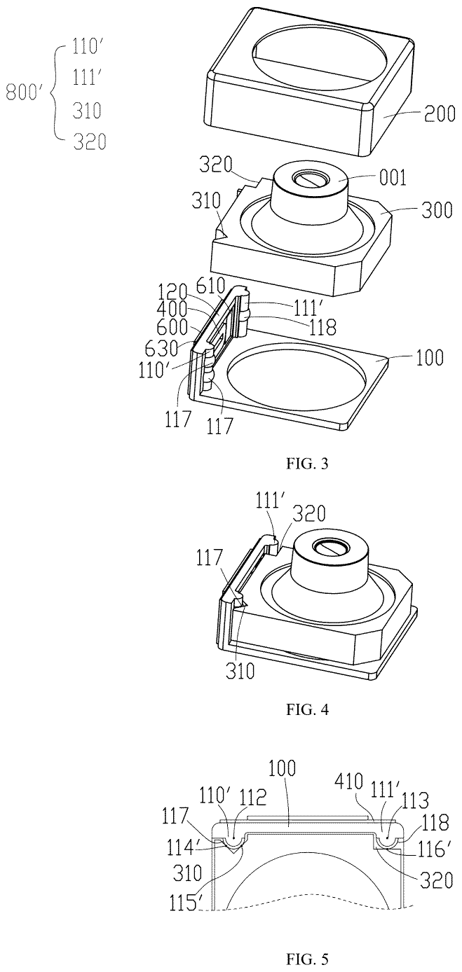

Please refer to FIG. 3 and FIG. 4, the lens driving device in this embodiment is similar in structure to the lens driving device in the first embodiment, therefore parts with the same structure are given the same reference numerals as in the first embodiment. The lens driving device in this embodiment also mainly includes a base 100, a cover 200 connected to the base 100, a carrier 300 used for carrying the lens 001, and a driving unit 400 used for driving the carrier 300 to move relative to the base 100. The driving unit 400 mainly includes a coil unit 410 and a magnet unit 420 (not shown). A guide unit 800′ used for guiding the movement of the carrier 300 is provided between the base 100 and the carrier 300. The guide unit 800′ includes a first guide member 110′, a second guide member 111′, a first guide groove 310, and a second guide groove 320. The first guide member 110′ and the second guide member 111′ are preferably integrally formed with the base 100, and the first guide groove 310 and the second guide groove 320 are preferably integrally formed with the carrier 300, and are both made of a non-conductive material, such as plastic.

Compared with the split/movable structure, the structure in which the first guide member 110′, the second guide member 111′ and the base 100 are integrally formed makes it unnecessary to assemble the guide during the assembly process, significantly reducing the assembly time and the required special tools, greatly simplifying the assembly process and shortening the product launch cycle. At the same time, it also eliminates errors caused by part assembly, improves the overall quality and yield of the product, and effectively saves costs. The integrated design of the first guide member 110′, the second guide member 111′ and the base 100 ensures that the positional accuracy of the first guide member 110′, the second guide member 111′ is much higher than that achievable by processing an independent guide member separately and then assembling it to the base. This high-precision positioning is achieved by precision machining the base 100 itself to ensure the straightness and stability of the carrier 300 when moving in focus along the optical axis, thereby reducing friction and deviation, thereby significantly improving the guidance performance and response speed of the lens driving device., has a direct and positive impact on imaging quality and user experience. The base 100 with the first guide member 110′ and the second guide member 111′ is fabricated by using an integrated molding technology. Compared with the use of independent metal first guide member 110′ and the second guide member 111′ in traditional lens driving devices, the base 100 not only reduces the weight, but also helps to reduce the overall volume, allowing the camera module to better meet the needs of today's market for thinness and thinness. There is no splicing gap between the first guide member 110′, the second guide member 111′ and the base 100 where they are located, which has high structural strength, better impact and vibration resistance, and effectively extends the service life of the lens driving device. During daily use or transportation, it is more resistant to damage from external forces, ensuring that the lens driving device can operate stably in various environments. The manufacturing process of the first guide member 110′ and the second guide member 111′ makes it easier to achieve automated mass production, which is conducive to the unification and standardization of product quality, reduces the defective rate of individual parts, and provides a solid quality for mass production. Quality guarantee.

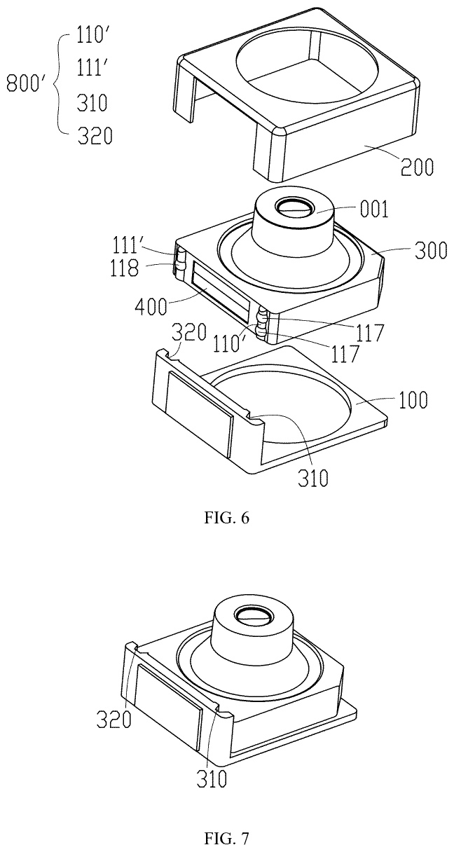

Please also referring to FIG. 5, in this embodiment, the first guide member 110′ and the second guide member 111′ each includes a substantially cylindrical part which extends substantially perpendicularly from a base board of the are base 100 along extending directions 112, 113 (shown as two points in FIG. 5). On the cylindrical part of the first guide member 110′ two protrusions 117 protruding towards the carrier 300 are arranged, and the surfaces of the protrusions 117 facing the carrier 300 are arc-shaped or hemispherical. The substantially cylindrical part of the second guide member 111′ has only one protrusion 118 protruding towards the carrier 300. The surface of the protrusion 118 facing the carrier 300 is arc-shaped or hemispherical. The outer side wall of the carrier 300 is provided with a first guide groove 310 and a second guide groove 320. The first guide groove 310 and the second guide groove 320 correspond to the first guide member 110′ and the second guide member 111′. In this embodiment, when viewed from the optical axis direction, the first guide groove 310 has a V shape, and the two surfaces forming the V shape are in point contact with the arc-shaped surface or hemispherical surface of each of the two protrusions 117 of the first guide member 110′, respectively, thereby generating four contact points 114′, 115′ (shown as two points in FIG. 5). The groove bottom of the second guide groove 320 is a plane, and the plane is substantially parallel to the winding plane of the coil unit 410. In use, only the groove bottom is in point contact with the arc-shaped surface or hemispherical surface of the protrusion 118 of the second guide member 111′, thereby generating only one contact point 116′ (shown as a point in FIG. 5). Therefore, the two protrusions 117 are in four-point contact with the first guide groove 310, and the protrusion 118 is in single-point contact with the second guide groove 320.

The contact points 114′, 115′ between the first guide member 110′ and the first guide groove 310 are at two sides of the extending direction 112 when viewed in a direction intersect with the extending direction 112 and perpendicular to the winding plane of the coil unit 410. The contact point 116′ is in a line which intersect with the extending direction 113 and perpendicular to the winding plane of the coil unit 410.

The first guide member 110′ has two protrusions 117 and is in four-point contact fit with the first guide groove 310. The guide member 111′ has only one protrusion 118 and is in single-point contact with the second guide groove 320, providing stable guide control and ensuring stable movement of the carrier 300 during the focusing process. The first guide groove 310 contacts the first guide member 110′ at multiple points, increasing the number of contact points, thereby enhancing the stability of the structure, which is crucial for maintaining precise focus of the lens under various use conditions. The second guide groove 320 is in single contact with the guide 111′, which reduces the friction generated when the carrier 300 moves, reduces the volume of the guide unit, effectively utilizes the limited space inside the lens driving device, and is particularly suitable for space limited miniaturized equipment, such as a camera of a smartphone. By optimizing space utilization, ultra-miniaturization of equipment can be achieved without sacrificing performance.

The coil unit 410 and the magnet unit 420 are opposed to each other with space. The coil unit 410 is fixed between the first guide member 110′ and the second guide member 111′, and the magnet unit 420 is fixed on the outer side wall of the carrier 300 and is located between the first guide groove 310 and the second guide groove 320. When the coil unit 410 is energized, the Lorentz force generated between the coil unit 410 and the magnet unit 420 may drive the carrier 300 to move relative to the base 100. In this embodiment, the coil unit 410 only includes one coil, the winding plane of the coil is parallel to the optical axis of the lens unit 001, and is generally in the shape of an oblong, and two long sides are perpendicular to the optical axis of the lens unit 001. The magnet unit 420 has two opposite polarities in a surface which faces the two long sides of the coil. In the embodiments, the magnet unit 420 includes two magnets opposed to the long sides of the coil respectively.

The configuration of a single coil unit 410 and a single magnet can greatly compress the height of the lens driving device without affecting performance.

In this embodiment, the first guide member 110′, the second guide member 111′ and the base 100 are integrally made of plastic.

Compared with metal, plastic is light, which effectively reduces the overall weight of the lens driving device and conforms to the trend of making electronic products thinner and thinner. It is especially suitable for mobile phone camera modules and can contribute to the lightness of terminal equipment. Plastic products have low cost, are easy to produce on a large scale, reduce manufacturing costs, and enable high-quality lens driving devices to be popularized in more consumer-grade products, benefiting consumers. Plastic has a certain degree of elasticity, can absorb vibration and impact to a certain extent, protect internal components, and improve the durability and life of the lens driving device.

In this embodiment, the two first guide member 110′ and the second guide member 111′ are substantially perpendicular to the base 100.

The two first guide member 110′ and the second guide member 111′ provide sufficient support points to ensure that the carrier 300 remains stable during the focusing process and reduces shaking. The symmetrical distribution enhances the sense of balance and improves the accuracy of motion. and reliability.

In this embodiment, the coil unit 410 is mounted on a circuit board 600. A chip 610 and a capacitor are also mounted on the circuit board 600. The coil unit 410, the chip 610 and the capacitor are arranged side by side on the same surface of the circuit board 600, and the other surface of the circuit board 600 is attached to a metal reinforcing plate 630. The base 100 further includes a connecting beam 120 connected between the upper ends of the two first guide member 110′ and the second guide member 111′. The connection beam 120, the first guide member 110′, the second guide member 111′, and a side edge of the base 100 constitute a frame for fixing the circuit board 600, and form an opening used for receiving the coil unit 410, the chip 610, and the capacitor, making the installation of the circuit board 600 easier and more stable. The metal reinforcing plate 630 may be made of iron or steel.

By arranging the coil unit 410, the chip 610, and the capacitor side by side on the same side of the circuit board 600, the overall volume of these components can be compressed. The design of adding a metal reinforcing plate 630 to the other side of the circuit board 600 effectively enhances the mechanical strength and impact resistance of the entire structure. The metal reinforcing plate 630 not only provides necessary physical protection to avoid line damage caused by external pressure or vibration, but also serves as a heat dissipation medium to help remove heat generated by internal components and maintain stable operation of electronic equipment in a high temperature environment. The magnetic attraction between the metal reinforcing plate 600 and the magnet unit 420 can also ensure that the first guide groove 310 and the second guide groove 320 maintain contact with the two first guide member 110′ and the second guide member 111′, ensuring guiding effectiveness.

Fixing the magnet on one side of the carrier 300 helps prevent the magnetic field from adversely affecting electrical components external to the lens driving device, such as reducing magnetic coupling effects, thereby improving the safety and reliability of the overall circuit. The coil unit 410 is fixed to one side of the base 100 to facilitate the layout of the power supply line.

### Third Embodiment

Please refer to FIG. 6 and FIG. 7, the lens driving device in this embodiment is similar in structure to the lens driving device in the second embodiment, in which parts with the same structure are given the same reference numerals as in the first embodiment and the second embodiment. The lens driving device in this embodiment also mainly includes a base 100, a cover 200 connected to the base 100, a carrier 300 used for carrying the lens 001, and a driving unit 400 used for driving the carrier 300 to move. The driving unit 400 includes a coil unit and a magnet unit, and a guide unit 800′ used for guiding the movement of the carrier 300 is provided between the base 100 and the carrier 300. The guide unit 800′ includes a first guide member 110′, a second guide member 111′, a first guide groove 310, and a second guide groove 320.

The difference between the third embodiment and the second embodiment is that the first guide groove 310 and the second guide groove 320 are provided on two pillars or a fixing plate (with an opening formed in the middle) integrally extending upwardly from a base plate of the base 100, and the first guide member 110′ and the second guide member 111′ are provided on the carrier 300. The first guide member 110′ and the second guide member 111′ are preferably integrally formed with the carrier 300, and the first guide groove 310 and the second guide groove 320 are preferably integrally formed with the base 100, and are both made of non-conductive material, such as plastic.

The working principle of the lens driving device of the third embodiment is the same as that of the lens driving device of the second embodiment.

Similar to the third embodiment, in a modified embodiment of the first embodiment, the first guide groove 310 and the second guide groove 320 may be provided on two pillars or a fixing plate (with an opening formed in the middle) integrally extending upwardly from a base plate of the base 100, and the first guide member 110 and the second guide member 111 are provided on the carrier 300. The first guide member 110 and the second guide member 111 are preferably integrally formed with the carrier 300, and the first guide groove 310 and the second guide groove 320 are preferably integrally formed with the base 100, and are both made of non-conductive material, such as plastic. The working principle of the lens driving device of the modified embodiment is the same as that of the lens driving device of the first embodiment.

In the first embodiment described above, there are two contact lines between the first guide member and the first guide groove, and there is only one contact line between the second guide member and the second guide groove. It will be understood that in other embodiments, the number of the contact lines may be increased as needed. For example, there may be three contact lines between the first guide member and the first guide groove (the first guide groove may be designed as a groove with three planes, so that all three planes are in contact with the arc-shaped surface of the first guide member), and at this time, there may be one contact line or two contact lines between the second guide member and the second guide groove (the second guide groove may be designed as a V shape or an L shape).

In the second and third embodiment described above, the first guide member 110′ includes two protrusions 117 protruding towards the carrier 300, and the second guide member 111′ includes one protrusion 118 protruding towards the carrier 300, so that there are four contact points between the first guide member 110′ and the first guide groove 310, and there is one contact point between the second guide member 111′ and the second guide groove 320. It will be understood that in other embodiments, the number of protrusions may be increased as needed. For example, the first guide member 110′ may include three or more protrusions 117, thereby having three or more arc-shaped surfaces or hemispherical surfaces, and having six or more contact points with the first guide groove 310, while the second guide member 111′ may also have two or more protrusions 114. Thereby having two or more contact points with the second guide groove 320.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A lens driving device, comprising:
a base;
a cover connected with the base to form a fixing part having a receiving space;
a carrier movably configured in the receiving space and configured for carrying a lens unit;
a driving unit configured for driving the carrier to move relative to the fixing part; and
a guide unit configured for guiding the carrier to move along an optical axis direction of the lens unit, the guide unit comprising:
a first guide groove;
a second guide groove;
a first guide member comprising one or two or two more arc-shaped surfaces or hemispherical surfaces protruding towards the first guide groove and arranged along a first direction parallel with the optical axis direction, the one or two or two more arc-shaped surfaces or hemispherical surfaces being in line or point contact with the first guide groove, and the number of contact lines or contact points being greater than or equal to 2; and
a second guide member comprising one or two or two more arc-shaped surfaces or hemispherical surfaces protruding toward the second guide groove and arranged along a second direction parallel with the optical axis direction, the one or two or two more arc-shaped surfaces or hemispherical surfaces being in line or point contact with the second guide groove, and the number of contact lines or contact points between the second guide member and the second guide groove being greater than or equal to 1;
wherein, the first guide groove is defined in one of the base and the carrier, and the first guide member is fixedly connected to the other of the base and the carrier; the second guide groove is defined in one of the base and the carrier, and the second guide member is fixedly connected to the other of the base and the carrier.

2. The lens driving device according to claim 1, wherein the first guide member and the second guide member are integrally formed with the base, and the first guide groove and the second guide groove are integrally formed with the carrier.

3. The lens driving device according to claim 1, wherein the first guide member and the second guide member each comprise a cylinder extending in a direction parallel to the optical axis direction, and the one or two or two more arc-shaped surfaces or hemispherical surfaces are formed on an outer sidewall of the cylinder.

4. The lens driving device according to claim 3, wherein a lubricant or gel is disposed between the first guide member and the first guide groove, and a lubricant or gel is disposed between the second guide member and the second guide groove.

5. The lens driving device according to claim 3, wherein the first guide groove has a V shape when viewed from the optical axis direction, and two surfaces forming the V shape are in line contact or point contact with the first guide member respectively.

6. The lens driving device according to claim 5, wherein when viewed from the optical axis direction, a groove bottom of the second guide groove is flat, and during the focusing process, only the groove bottom is in line contact or point contact with the second guide member, and the rest of the second guide groove is not in contact with the second guide member.

7. The lens driving device according to claim 1, wherein the driving unit comprises a coil member fixed on the base and a magnet member fixed on the outer side wall of the carrier; a winding plane of the coil member is parallel to the optical axis direction of the lens unit; and the coil member and the magnet member are opposed to each other with space.

8. The lens driving device according to claim 7, wherein the driving unit is configured between the first guide member and the second guide member.

9. The lens driving device according to claim 7, wherein the coil member comprises only one coil.

10. The lens driving device according to claim 7, wherein the driving unit further comprises a circuit board, a chip and a capacitor, and the coil, chip and capacitor are fixed on a surface of the circuit board facing the carrier.

11. The lens driving device according to claim 10, wherein the driving unit further comprises a metal reinforcing plate fixed on the other surface of the circuit board.

12. The lens driving device of claim 11, wherein the coil, chip and capacitor are arranged side by side.

13. The lens driving device according to claim 7, wherein the first guide member, the second guide member and the base are made of plastic.

14. A camera, comprising the lens driving device according to claim 1.

15. An electronic device, comprising the camera according to claim 14.
